(19) United States
(12) Patent Application Publication
(10) Pub. No.: US 2011/0136537 A1
(43) Pub. Date: Jun. 9, 2011

(54) COMMUNICATION DEVICE WITH HEARING-AID FUNCTIONALITY

(76) Inventor: Rainer MARTERER, Speichersdorf (DE)

(21) Appl. No.: 13/003,304

(22) PCT Filed: Jul. 2, 2009
(86) PCT No.: PCT/EP2009/004800

§ 371 Date: Feb. 17, 2011

(30) Foreign Application Priority Data
Jul. 14, 2008 (DE) 10 2008 032 852.9

(51) Int. Cl. H04W 88/02

(52) U.S. Cl. 455/556.1

(57) ABSTRACT

The invention relates to a mobile communications device (A, B) which can be used as a hearing aid and operated in a first operating mode in which acoustic signals are registered by at least one microphone (1, 1a, 1b, 16a, 16b) and fed to a transmission device (5) for transmission via a telecommunications network, and can be operated in a second operating mode in which the signals registered by the microphone (1, 1a, 1b, 16a, 16b) are fed to an audio-outputting signal path (11) with a loudspeaker unit (10), wherein the communications device has a signal switch (3) for switching over from the first operating mode to the second operating mode.

The invention relates to a mobile communications device that can be operated in a first operating mode in which acoustic signals are registered by at least one microphone and fed to a transmission unit for transmission via a telecommunications network.

Cordless end-user devices for landline telephony, mobile telephones and headsets that are used together with landline or mobile telephones are equipped as standard with a microphone into which the user of the device speaks when telephoning. These acoustic signals are registered by the microphone and after digitizing, if necessary, fed to a transmission unit that transmits the voice signals via a telecommunications network. Furthermore, an end-user device of this kind receives voice signals from a telecommunications partner, which are emitted by a loudspeaker provided in the telecommunications end-user device.

Hearing aid devices have a microphone that registers acoustic, voice and ambient signals, which are then amplified and fed to a loudspeaker that, in its turn, emits the acoustic signals immediately upon signal registration. Hearing aids are today sophisticated custom-made devices that are adapted individually for a specific person by a hearing aid acoustics technician. Technically, they have a relatively complex construction and generate a hearing perception that comes very close to that of natural hearing. Because of their complexity and personalization, the price of hearing aid devices is relatively high. There is therefore a general need, at least among persons with impaired hearing, to incorporate a hearing aid functionality in a readily available device that can be manufactured at relatively low cost, such as a telecommunications end-user device.

The object of the invention is therefore to provide a communications device that has not only a conventional communication function but also a hearing aid function and that, in comparison with a hearing aid device, can be obtained at a relatively low price and used in a flexible manner.

This object is achieved by a communications device with the features set forth in claim 1.

According to the invention, a mobile communications device is proposed that can be operated in a first operating mode in which acoustic signals are registered by at least one microphone and fed to a transmission unit for transmission via a telecommunications network, wherein the communications device can additionally be operated in a second operating mode in which the signals registered by the microphone are fed to an audio-outputting signal path with a loudspeaker unit, and wherein the communications device has a signal switch to switch over from the first operating mode to the second operating mode.

In the first operating mode, the communications device—which can be a communications end-user device such as a DECT telephone (Digital European Cordless Telephony) or a mobile telephone, or a headset that can be connected to one of these telecommunications end-user devices—can be used in its conventional telephone function in which the user of the device speaks into the microphone of the device, the voice signals are fed to a transmission unit and the transmission unit transmits these via the telecommunications network, for example a landline telephone network or a mobile telephone network, to the other party in the conversation. Furthermore, in the first operating mode, voice signals of the telecommunications partner are received in a receiver unit that feeds these to an audio-outputting signal path terminating in a loudspeaker through which the voice signals are emitted.

In accordance with the invention, the provision of a signal switch makes it possible to switch over from one signal path to another signal path. In particular, the acoustic signals registered by the microphone can be fed via the signal switch either to the transmission unit or to the audio-outputting signal path. The signal switch can thus execute a switch-over from a first operating mode, which can be designated as telephone mode, to a second operating mode, which can be designated as hearing aid mode. In this especially advantageous way, the telecommunications end-user device can, when it is not being used for telephoning, be used as a hearing aid, wherein voice signals and/or background signals originating from the surrounding space that are registered by the microphone are emitted in amplified form through the loudspeaker, directly and simultaneously with the signal registration.

Preferably, the at least one microphone and the loudspeaker unit can be integrated in the telecommunications end-user device. This has the advantage that no additional devices have to be procured and used in order to make the hearing aid function utilizable. The telecommunications end-user device can be used as required and does not need to be worn continuously at the ear the way a hearing aid does.

In an advantageous development of the invention, a first microphone for registering voice signals and a second microphone for registering background signals can be provided in the telecommunications end-user device. This considerably increases the hearing quality since each of the two microphones can be oriented to a specific direction from which the signals to be registered originate. Since microphones have individual directional characteristics, meaning that sound from a specific angle of incidence is better registered than sound from other angles of incidence, a first microphone can be oriented toward the mouth area of the device user and thus essentially be oriented in the same direction as the emission direction of the loudspeaker. By contrast, the second microphone, which is designed, in particular, as an ambient microphone, can preferably be oriented in an opposite direction or facing away from the direct voice sound and in a direction from which ambient noise reaches the telecommunications end-user device. The use of two microphones specializing in specific types of signals additionally permits differentiated signal processing, since different filters or frequency amplifications have to be provided for the voice signals registered as direct sound than for background signals representing ambient sound.

Preferably, the two microphones can be combined into one single microphone, i.e. in a microphone capsule. Alternatively, the two microphones can be developed as a single microphone that has switchable directional characteristics. This is, in particular, possible because the two microphones do not have to be used at the same time. Rather, the voice-signal-registering first microphone is used only for the telephone mode while the background-signal-registering second microphone is used only for the hearing aid mode. By using one single microphone it is possible to save costs as well as space within the device.

Advantageously, the telecommunications end-user device can furthermore be connected communicatively with a headset, and the headset have at least one microphone and a loudspeaker unit. In this embodiment of the invention, the typical known functionality of a hearing aid can be transferred to a headset used with the telecommunications end-user device, with the said headset being worn on the ear of the device user like a conventional hearing aid. This eliminates the need to hold the communications device itself to the ear, which is relatively cumbersome and becomes unpleasant over time.

Furthermore, the headset can have a first microphone for registering voice signals and a second microphone for registering background signals. This results in the same advantages as already presented above in relation to the is telecommunications end-user device. Having two microphones makes it possible to direct each of these in a specific direction from which a specific type of acoustic signals comes and to process these different types of sound individually and for specific purposes that can considerably improve the hearing quality for the device user.

When using two microphones, each of these can be connected in series with a diode and the two series circuits consisting of diode and microphone can, in their turn, be connected anti-parallel to each other. This has the effect that, upon applying an operating voltage to the series circuit and selecting the polarity of the operating voltage, either the first microphone or the second microphone may be operated at will. This makes it possible in a simple manner to switch over between the first microphone used in the first operating mode and the second microphone used in the second operating mode by changing the polarity of the operating voltage. In an alternative embodiment variant, it is also possible with one microphone having two different directional characteristics to switch over from the first directional characteristics to the second directional characteristics using the said kind of operating voltage polarity reversal. A switching of this kind between microphones or directional characteristics can be implemented in the telecommunications end-user device or the headset. Alternatively, any other form of switching between or of microphones is possible, e.g. logic gating or a use of digital signal processors.

In an advantageous development of the invention, an equalizer can be provided for frequency-specific changing of the acoustic signals. An equalizer of this kind represents in this case a frequency-selective filter that amplifies individual frequencies and/or attenuates other frequencies in the frequency spectrum of the registered signal. With the help of the equalizer it is possible to adjust the hearing acoustics of the telecommunications end-user device in a targeted manner for the user of the device and so to offer the user the best possible hearing perception for this person.

In this respect, the equalizer can preferably be arranged in the audio-outputting signal path. In this way, it is possible to achieve frequency-selective filtering and/or amplification in both operating modes.

Furthermore, the telecommunications end-user device and/or headset can have a memory in which a profile is stored that defines the frequency-specific change in the acoustic signals. Such a profile can be individually adapted to the device user. In this respect, it is possible to create several profiles and to store these in an internal or external storage medium so that different persons can use the telecommunications end-user device, each individual being thus able to enjoy an optimal hearing quality for their needs.

According to the invention, the telecommunications end-user device and the headset can be connected to each other via a cable. In an alternative embodiment variant, the headset and the telecommunications end-user device can be connected via a radio connection. Preferably, the headset can be connected to the telecommunications end-user device via Bluetooth® technology. This achieves an especially high degree of flexibility.

In an especially advantageous embodiment of the invention, the signal switch can be designed so as to execute automatic switching from the second operating mode to the first operating mode when a telephone call is initiated. Similarly, the signal switch can be designed so as to execute automatic switching from the first operating mode to the second operating mode when a telephone call is ended. Accordingly, the telecommunications end-user device or the set consisting of headset and telecommunications end-user device can be used in the standard case as a hearing aid device, with the signal switch executing an automatic switch-over to telephone mode if there is an incoming call or the device user wishes to telephone.

In a special aspect of the invention, the communications device is a headset into which is integrated the signal switch according to the invention and that can be connected to a telecommunications end-user device in order to use the telephone mode, wherein in this case, a transmission unit of the telecommunications end-user device is used. A headset of this kind can have the same features and hence the same advantages as a previously described headset without signal switch, in which the signal switch provided in the telecommunications end-user device in accordance with the invention is used for switching from the first operating mode to the second operating mode.

Further advantages, features and possible applications of the invention are described in more detail below in relation to exemplary embodiments with reference the figures, in which

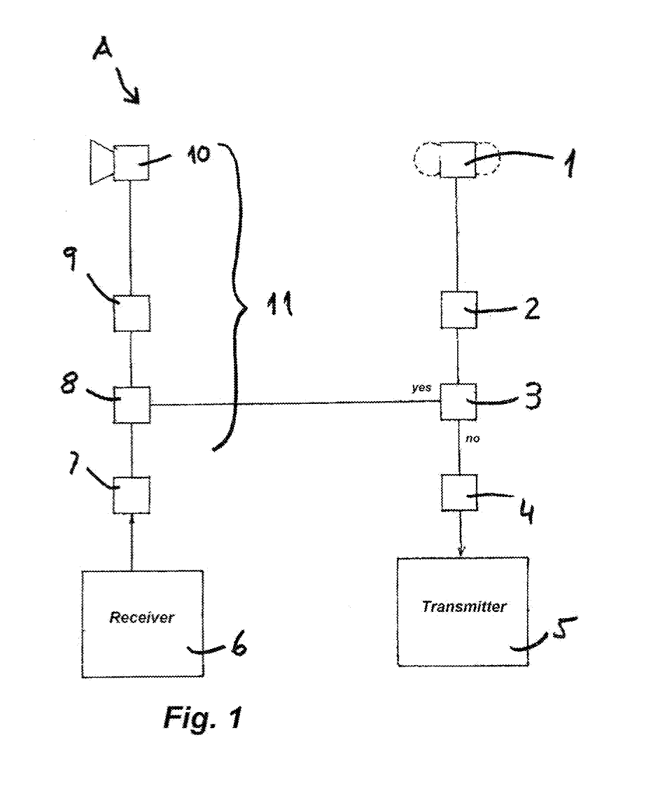

FIG. 1 shows a block circuit diagram with signal paths,

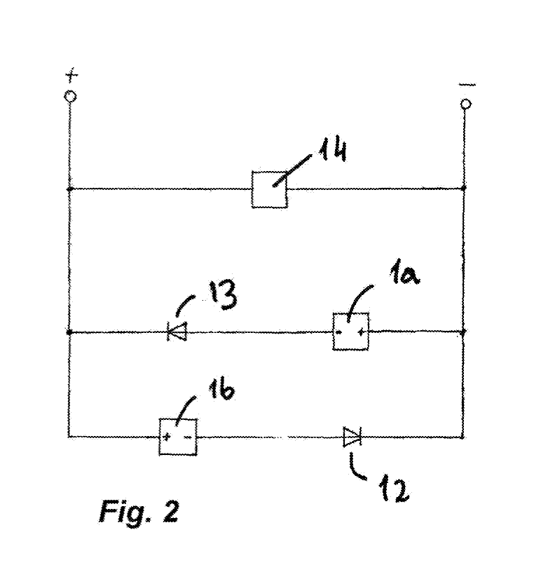

FIG. 2 shows a circuit diagram with dual microphone,

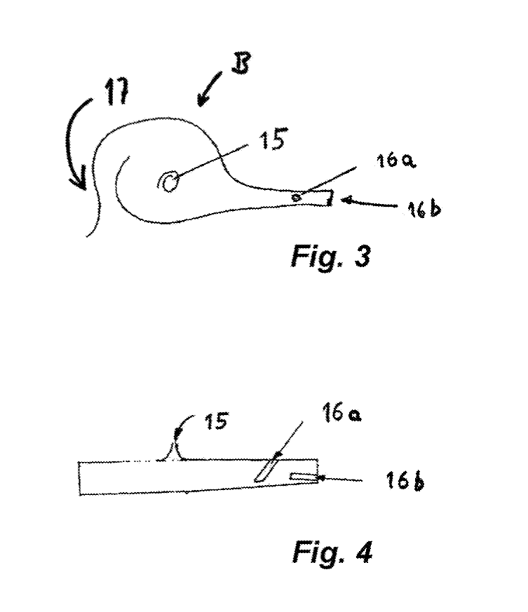

FIG. 3 shows a side view of a headset with dual microphone,

FIG. 4 shows a top view of a headset with dual microphone.

In an exemplary embodiment variant, the telecommunications end-user device is a mobile telephone and has, in addition to its first, customary operating mode, in which the mobile telephone can be used as a telephone, a hearing aid functionality, which allows the mobile telephone to be used as a hearing aid in a second operating mode.

It may be observed that our society is aging at an increasingly fast rate. Older people frequently have hearing problems due to a variety of reasons. But even the younger generations are not excluded from this trend. At the same time, the financial purchasing power to procure hearing aid devices is decreasing. A mobile telephone has become an indispensable part of daily life for almost everyone. It is therefore especially advantageous to integrate the function of a hearing aid into the mobile telephone so as to be able to offer significant added value in a mobile telephone, especially to people with impaired hearing. This is a low-cost alternative to a custom-adjusted hearing aid device. Moreover, it improves the voice quality for the individual during mobile telephone calls. In addition, the integration of the hearing aid functionality into the mobile telephone offers the possibility of avoiding the use of environmentally harmful batteries in hearing aid devices since mobile telephones and headsets can be supplied with energy through rechargeable batteries.

FIG. 1 shows a general block circuit diagram of the invention that is integrated here, by way of example, in a telecommunications end-user device A developed as a mobile telephone. The mobile telephone A has a microphone 1 for registering voice signals and/or background signals. The microphone 1 is developed as a dual microphone and has two different directional characteristics, owing to which the microphone is capable of registering sound from a first preferred direction, in particular from the mouth region of the mobile telephone user, and sound from a second preferred direction, in particular from the area surrounding the device user. The registered acoustic signals are amplified with the help of a pre-amplifier 2 and fed to a signal switch 3. The latter decides according to the criterion of whether a telephone call is being initiated, is active, or is being ended, whether the amplified signals are to be fed to a first signal path comprising a transmission unit 5 or to a second, audio-outputting signal path 11.

In the case of a telephone call, the mobile telephone A is operated in a first operating mode in which the voice signals registered by the microphone 1 are fed to an A/D converter 4 that converts the acoustic signals into a digital signal. The digital signals are then fed to the transmission unit 5, which modulates the digital signal and transmits it to the other party in the telephone conversation via a mobile telephone network.

Conversely, digital voice signals coming from the other party are received in a receiver unit 6 of the mobile telephone A, demodulated and fed to a D/A converter 7 that converts the digital signal into an analog acoustic signal. This signal is fed to an equalizer 8 connected to a following output amplifier 9. The latter amplifies the acoustic signal that is finally output to a loudspeaker 10. The equalizer 8, output amplifier 9 and loudspeaker 10 form in this case the audio outputting channel 11.

In accordance with the invention, the signal switch 3 allows switching over from the first shown signal path, comprising the transmission unit 5 and the loudspeaker of the telecommunications end-user device of the party to the telephone conversation, to the audio outputting signal path 11 of the mobile telephone A. This preferably takes place when a telephone call is terminated.

In this second operating mode, the acoustic signals registered by the microphone 1 are amplified by the pre-amplifier 2 and conducted via the signal switch 3 directly to the equalizer 8, then amplified by the output amplifier 9 and emitted via the loudspeaker 10. Via this signal path 11 , the acoustic signals registered by the microphone 1 are output again simultaneously and in amplified form to the loudspeaker 10 such that the mobile telephone A is operated in a hearing aid mode.

In accordance with the invention, the microphone 1 can have two different directional characteristics. In this embodiment, the microphone 1 is to be considered quasi as two microphones 1a, 1b, wherein either the microphone 1a with the one directional characteristic or the microphone 1b with the other directional characteristic is operated. Regarding the electrical control, the two directional characteristics can be considered as two separate microphones 1a, 1b. Alternatively, instead of one microphone 1, two spatially separated microphones 1a, 1b may also be provided that, on account of their spatial separation, offer greater flexibility and adaptability to the sound direction.

FIG. 2 shows an electrical circuit diagram for controlling the two microphones 1a, 1b, which can also be considered as representative of the two directional characteristics of the microphone 1. The two microphones 1a, 1b are connected in each case by means of their negative pole to the anode of a diode 12, 13 and thus connected in series with these diodes 12, 13. The positive pole of the first microphone 1a is connected to the cathode of the second diode 12, the cathode of the first diode 13 to the positive pole of the second microphone 1b. Because of this circuitry, the series circuit consisting of the first microphone 1a and the first diode 13 is connected anti-parallel to the series circuit consisting of the second microphone 1b and the second diode 12. Furthermore, an audio output 14 of the microphone elements 1a, 1b is connected parallel to the series circuits.

The first microphone 1a is designed to register voice signals, the second microphone 1b to register ambient signals. A switch-over from ambient mode to telephone mode is possible by reversing the polarity of a feed voltage that is to be applied to the series circuits. If, for example, the positive potential of the operating voltage is present at the cathode of the second diode 12 and hence at the positive pole of the first microphone 1a, the latter will be in operation, which represents the first operating mode, i.e. telephone mode. If the polarity of the feed voltage is reversed, its positive potential will be applied to the cathode of the diode 13, i.e. to the positive pole of the second microphone 1b, so that the latter is in operation and an ambient signal is output to the loudspeaker 10, 15. This state characterizes the second operating mode, i.e. the hearing aid mode. The circuitry according to FIG. 2 can be implemented in a telecommunications end-user device or in a headset.

FIG. 3 shows schematically a headset B with a loudspeaker 15 and two spatially separated microphones 16a, 16b. The headset B is equipped with a hook 17 so that it can be attached to an ear of the mobile telephone user. In this state, the loudspeaker 15 is oriented in the direction of the ear canal. The latter can be seen in the side view according to FIG. 4.

In the attached state of the headset B, the first microphone 16a is oriented in the direction of the mouth area of the wearer for registering voice signals, whereas the second microphone 16b is oriented away from the mouth area of the wearer for registering background signals, in particular signals originating from the surroundings of the headset B. The second microphone 16b is rotated about 80° relative to the first microphone 16a and is active in the ambient direction so that an adequate decoupling from the voice signal is assured.

The headset B according to FIGS. 3 and 4 is equipped with Bluetooth® technology that allows it to connect to the mobile telephone A by radio signals. In this state, the microphone 1 or the microphones 1a, 1b and the loudspeaker 10 of the mobile telephone A are not used. Instead, in the telephone mode, voice signals registered by the first microphone 16a are fed via the signal switch 3 located in the mobile telephone to the transmission unit 5, while incoming signals from the other party to the conversation are output via the loudspeaker 15.

Furthermore, in the hearing aid mode, signals registered by the second microphone 16b are fed by the signal switch 3 of the mobile telephone directly to the audio outputting signal path of the headset B. The pre-amplifier 2, the signal switch 3, the equalizer 8 and/or the output amplifier 9 can be provided either in the mobile telephone A or the headset B. The signal switch can be developed as a mechanical switch so that the user can perform a manual switch-over. It can, however, also be developed as an electronic switch so that an automatically controlled switch-over upon call initiation or call termination is possible.

The equalizer 8 should cover a sufficient number of frequency ranges, i.e. of channels. An audio signal can be amplified or changed by the equalizer in a channel-specific manner depending on the setting of the equalizer. The settings for signal strength for the individual channels and the overall signal, as well as the tone quality can be adjusted, set and stored in the mobile telephone A by the mobile telephone user him/herself. Furthermore, predefined profiles can be stored in the mobile telephone A.

The arrangement of the components in the block circuit diagram according to FIG. 1 offers the advantage that even incoming telephone calls can already be adapted to the individual hearing capacity of the respective user. This improves the perceived voice quality. A further advantage is that the individually created profile can be saved as a file and also transferred to other devices, for example to handless units or other audio-outputting devices such as the headset B.

During active telephony connections, the first microphone 1a, 16a is responsible for the pure voice transmission to the callee. The equalizer in the mobile telephone A works only in the audio-outputting signal path where it changes the incoming voice signals of the callee in a frequency-specific manner according to the settings made.

If no telephone call is being conducted, the signal of the ambient microphone 1b, 16b is amplified by the equalizer 8 in the output signal path 11 and the hearing aid function is in operation. The ambient microphone 1b, 16b may be located at the person, at the mobile telephone A, at the Bluetooth headset B or at another suitable point.

If another person uses the mobile telephone A, the equalizer function can be switched off or bridged. Alternatively, the other person can activate a personal profile assigned to him/her for the equalizer, which can be stored as a file with a special format in the mobile telephone, in another storage medium, or, for example on the Internet and can be loaded from this storage location.

1-14. (canceled)

15. A mobile communications device that can be operated in a first operating mode in which acoustic signals are registered by at least one microphone and fed to a transmission device for transmission via a telecommunications network, whereas it can be operated in a second operating mode in which the signals registered by the microphone are fed to an audio-outputting signal path with a loudspeaker unit and that it has a signal switch for switching over from the first operating mode to the second operating mode, the device comprising
an equalizer for frequency-specific changing of the acoustic signals, and
a memory that allows the storage of profiles of the frequency-specific change of the acoustic signals, in particular the saving to external media, in particular to a memory card and/or the storage of the profile in a suitable storage site on the internet through the establishment of a data connection.

16. A mobile communications device according to claim 15 wherein it is a telecommunications end-user device.

17. A mobile communications device according to claim 15 wherein it is a headset that is connectable for the first operating mode to a telecommunications end-user device.

18. A mobile communications device according to claim 15, further comprising
at least one microphone and the loudspeaker unit.

19. A mobile communications device according to claim 15, further comprising
a first microphone for registering voice signals and a second microphone for registering background signals.

20. A mobile communications device according to claim 1, wherein the microphone has switchable directional characteristics.

21. A mobile communications device according to claim 20, wherein the microphone elements are in each case connected in series with a diode and the series circuits consisting of diode and microphone elements are connected anti-parallel to each other.

22. A mobile communications device according to claim 15 wherein the equalizer is arranged in the audio-outputting signal path.

23. A mobile communications device according to claim 22 or 9, further comprising
a memory in which a profile of the frequency-specific change of the acoustic signals is stored.

24. A mobile communications device according to claim 17, wherein it is in radio contact with the telecommunications end-user device.

25. A mobile communications device according to claim 15, wherein the signal switch is adapted to execute automatic switching from the second operating mode to the first operating mode when a telephone call is initiated.

26. A mobile communications device according to claim 15, wherein the signal switch can be designed so as to execute automatic switching from the first operating mode to the second operating mode when a telephone call is terminated.
